(19) United States
(12) Patent Application Publication
(10) Pub. No.: US 2008/0211653 A1
(43) Pub. Date: Sep. 4, 2008

(54) Vehicle with Interior Video Display for Exterior View

(75) Inventor: Richard C. Cope, Duluth, GA (US)

Correspondence Address: SUTHERLAND ASBILL & BRENNAN LLP, 999 PEACHTREE STREET, N.E., ATLANTA, GA, 30309, US

(73) Assignee: NANOLUMENS ACQUISITION, INC., Norcross, GA (US)

(21) Appl. No.: 11/743,299

(22) Filed: May 2, 2007

Related U.S. Application Data
(63) Continuation-in-part of application No. 11/681,250, filed on Mar. 2, 2007.

(51) Int. Cl. B60Q 11/00

(52) U.S. Cl. 340/461

(57) ABSTRACT

The present invention relates generally to vehicle display systems, vehicles comprising vehicle display systems, and methods of operating vehicles comprise vehicle display systems. In particular, the vehicle display systems comprise a detection device adapted to receive physical signals from outside the vehicle and generate data signals in response to the physical signals; a display module adapted for communication with the detection device, wherein the display module is adapted to receive the data signals from the detection device and to generate control signals in response to the data signals; and a display unit comprising at least a first flexible addressable display panel adapted for communication with the display module, wherein the first flexible display panel is adapted for mounting inside the vehicle and to receive at least some of the control signals from the display module and to generate at least a portion of the view simulating image in response to the at least some of the control signals.

This application is a continuation-in-part of co-pending U.S. patent application Ser. No. 11/681,250, titled “Dynamic Vehicle Display System,” filed Mar. 2, 2007 the disclosure of which is expressly incorporated herein by reference.

### FIELD OF THE INVENTION

The present invention relates to vehicle display systems, and more particularly, to vehicle display systems for displaying view simulating images inside a vehicle.

### BACKGROUND

Vehicles such as automobiles, tanks, watercraft, and aircraft may include windows to provide the vehicle operator or passenger with a visible image of the vehicle's surroundings. These windows are usually arranged to provide the vehicle operator with a forward facing view, a rearward facing view, and one or more side facing views.

Although fit for its intended purpose, windows have several drawbacks. Window size is limited by the need for structural strength in the body or hull of the vehicle. This size limitation prevents the vehicle operator from obtaining a full image of the vehicle's surroundings. Window location is limited by the need for structural supports, such as pillars, and by the need for vehicle accessories, such as spoilers. This location limitation also prevents the vehicle operator from obtaining a full image of the vehicle surroundings. Windows also represent safety concerns, as they usually are less effective at protecting a vehicle operator than the body or hull of a vehicle. What is desired, therefore, is a device and method that can provide the vehicle operator with a visible image of the surroundings of the vehicle, without the need for a window.

A further disadvantage of windows is the limited types of information that they provide the vehicle operator. Although windows provide some visual information, they are not able to provide a simulated image of light falling outside the visible spectrum, such as infrared or ultraviolet light. Furthermore, windows are unable to provide a simulated image of sound, heat, electromagnetic signals, electric fields, and magnetic fields. This lost information may be extremely valuable in a number of vehicles and situations. For example, information regarding light falling outside the visible spectrum is valuable in vehicles that operate at night, information regarding sound and/or electric fields is valuable in vehicles traveling in water, and information regarding electromagnetic signals is valuable in vehicles that utilize radar. What is desired, therefore, is a device and method that can provide the vehicle operator with a simulated image representing all types of information.

Yet another disadvantage of windows is their lack of customization. Windows designed for use in high levels of light (for example, tinted windows), are unsuitable for use in low levels of light. Furthermore, windows, which are designed to provide visual information, are often completely unsuitable for providing information regarding non-visible light, sound, heat, electromagnetic signals, electric fields, and magnetic fields. What is desired, therefore, is a device and method that can provide the vehicle operator with a customized simulated image representing any desirable type of information. In addition, it would be desirable to allow the vehicle operator to adjust the types of information represented in the simulated image to his or her own preferences.

Another disadvantage of windows is their inability to automatically change the type of information represented in the simulated image in response to a predetermined change in operating conditions. As mentioned above, windows only transmit visible light, and only are effective in a limited range of light conditions. As operating conditions change, windows are unable to automatically adjust the type of information conveyed to match the needs of the operator in the changed conditions. What is desired, therefore, is a device and method that can automatically change the type of information represented in the simulated image in response to a predetermined change in operating conditions. For example, if operating conditions change from light to dark, it may be desirable to enhance the spectral range of the light represented in the simulated image, and/or enhance the intensity range of the light represented in the simulated image.

These aforementioned problems have led to an increased interest in the use of addressable displays, such as Liquid Crystal Displays (LCDs), to provide information to vehicle operators. However, prior art addressable displays have several drawbacks which have limited their use in vehicles. First, addressable displays tend to be expensive, and many are of insufficient quality or brightness for use in displaying visible images of the exterior of the vehicle. In addition, addressable displays, such as LCDs, tend to be rigid and planar, making them difficult to incorporate into the non-planar surfaces found in most vehicles. Furthermore, addressable displays tend to be heavy, resulting in decreased vehicle performance, and bulky, taking up valuable space in a vehicle cockpit. Many addressable displays, such as LCDs, also require large light sources for backlighting, which can generate undesirable heat levels. Still further, many addressable displays have power requirements which are too high for use in most vehicles. Thus, the use of addressable displays in vehicles has generally been limited to one or two small displays, such as an automobile navigation display that is not located in the main instrument panel. U.S. Patent Publication No. 2005/0030256A1 to Tubidis et al. entitled “Conformable Vehicle Display” discloses the concept of using an addressable display in a vehicle. In Tubidis, a flexible display is coupled to a rigid substrate which in turn is coupled to a surface of a vehicle. Both the display and the substrate are transparent so that when the display is not activated an operator can see the surface of the vehicle to which the display and the rigid substrate are attached. Tubidis has the disadvantage of using an additional rigid substrate for mounting the display on a vehicle surface.

What is desired, therefore, is a device and method that can provide the vehicle operator with a visible image of the surroundings of the vehicle, without the need for a window. What also is desirable is a device and method capable of creating an image of such surroundings on a display panel mounted directly on a non-planar surface of the vehicle. It also is desirable for the image to represent any type of physical information, for the image to be customizable by the operator, and for the image to automatically change the type of information represented in the simulated image in response to a predetermined change in operating conditions.

### SUMMARY OF THE INVENTION

The present invention provides a vehicle display system for providing a view simulating image inside a vehicle based on physical signals from outside the vehicle. In one exemplary embodiment, the vehicle display system includes a detection device adapted to receive physical signals from outside the vehicle and generate data signals in response to the physical signals; a display module adapted for communication with the detection device, wherein the display module is adapted to receive the data signals from the detection device and to generate control signals in response to the data signals; and a display unit comprising at least a first flexible addressable display panel adapted for communication with the display module, wherein the first flexible display panel is adapted for mounting inside the vehicle and to receive at least some of the control signals from the display module and to generate at least a portion of the view simulating image in response to the at least some of the control signals.

The present invention also provides a vehicle comprising a carrier and a vehicle display system for providing a view simulating image inside a vehicle based on physical signals from outside the vehicle. In an exemplary embodiment, the vehicle display system includes a detection device adapted to receive physical signals from outside the vehicle and generate data signals in response to the physical signals; a display module adapted for communication with the detection device, wherein the display module is adapted to receive the data signals from the detection device and to generate control signals in response to the data signals; and a display unit comprising at least a first flexible addressable display panel adapted for communication with the display module, wherein the first flexible display panel is adapted for mounting inside the vehicle and to receive at least some of the control signals from the display module and to generate at least a portion of the view simulating image in response to the at least some of the control signals.

The present invention also provides a method of navigating a vehicle. In an exemplary embodiment, the method comprises receiving physical signals from outside the vehicle with a detection device; generating data signals with the detection device in response to the physical signals; receiving the data signals with a display module; generating control signals with the display module in response to the data signals; receiving at least a portion of the control signals with a display unit comprising at least a first flexible addressable display panel mounted inside the vehicle; generating at least a portion of a view simulating image with the flexible display panel in response to the control signals; and navigating the vehicle in response to the view simulating image.

### BRIEF DESCRIPTION OF THE DRAWINGS

FIG. 1 shows a side view of an embodiment of the display panel.

FIGS. 2A-2C show various embodiments of the display panel.

FIG. 3 shows a method of incorporating the display panel into the vehicle.

FIG. 4 shows a vehicle in accordance with an embodiment of the invention.

### DETAILED DESCRIPTION

Reference now will be made in detail to the presently proffered embodiments of the invention. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment can be used on another embodiment to yield a still further embodiment. Thus, it is intended that the present invention cover such modifications and variations within the scope of the appended claims and their equivalents.

Embodiments of this invention include vehicle display systems and vehicles comprising vehicle display systems. In one embodiment, the vehicle display system comprises a detection device adapted to receive physical signals from outside the vehicle and generate data signals in response to the physical signals; a display module adapted for communication with the detection device, wherein the display module is adapted to receive the data signals from the detection device and to generate control signals in response to the data signals; and a display unit comprising at least a first flexible addressable display panel adapted for communication with the display module, wherein the first flexible display panel is adapted for mounting inside the vehicle and to receive at least some of the control signals from the display module and to generate at least a portion of the view simulating image in response to the at least some of the control signals. Also embodied in this invention are methods for navigating a vehicle comprising receiving physical signals from outside the vehicle with a detection device; generating data signals with the detection device in response to the physical signals; receiving the data signals with a display module; generating control signals with the display module in response to the data signals; receiving at least a portion of the control signals with a display unit comprising at least a first flexible addressable display panel mounted inside the vehicle; generating at least a portion of a view simulating image with the flexible display panel in response to the control signals; and navigating the vehicle in response to the view simulating image.

The present invention is applicable any type of vehicle or carrier, such as, by way of example and not limitation, aircraft, watercraft, cars, trucks, ATVs, motorcycles, tanks, and the like. In the following description and claims, the term “coupled” may mean that two or more elements are in direct physical or electrical contact. However, “coupled” may also mean that two or more elements are not in direct contact with each other, but yet still cooperate or interact with each other such as when two elements are in communication with one another but not touching.

### I. Display Unit

In a particular embodiment, the vehicle display system includes a display unit. The display unit desirably comprises at least a first flexible addressable display panel. In particular embodiments, the display unit is mounted directly on an interior surface of the vehicle. At least a portion of the interior surface may be non-planar.

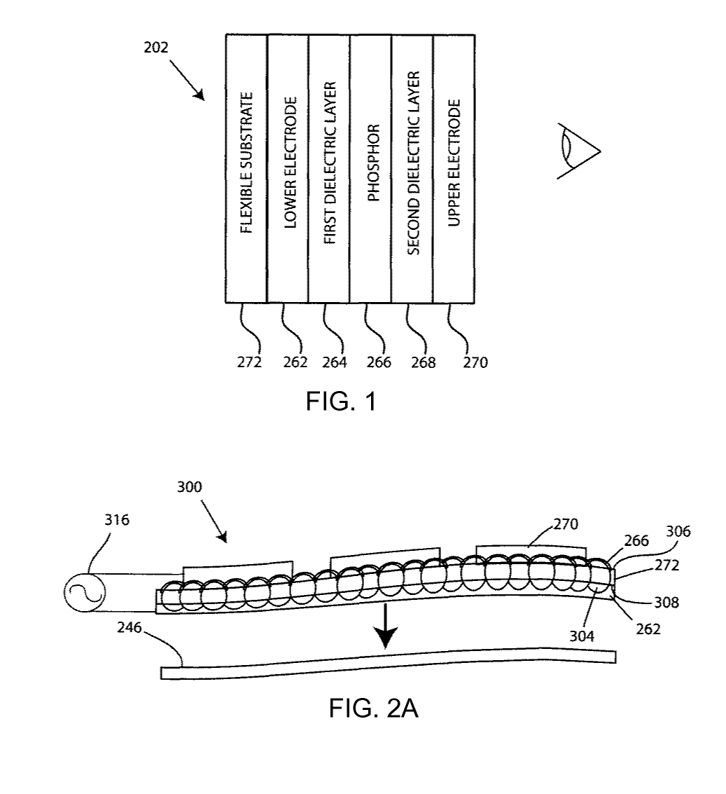

As shown in cross section in FIG. 1, the display panel 202 may be in the form of a flexible electroluminescent display that generally comprises a first electrode layer 262, a first dielectric layer 264, a phosphor layer 266, a second dielectric layer 268, a second electrode layer 270, and a flexible substrate 272. The first 262 and second 270 electrode layers may be arranged in orthogonal columns and rows respectively to form a matrix-addressed array. The cross over of the first 262 and second 270 electrodes defines an addressable pixel 240 which may be driven to emit light having the required characteristics to generate a desired image.

The display unit may further comprise a drive unit to supply the appropriate voltages so that the phosphor layer 266 generates light in a desired color and pattern. The pixels 240 may include a variety of different phosphors that may be arranged to form an emissive color display and additional charge injection layers may be added.

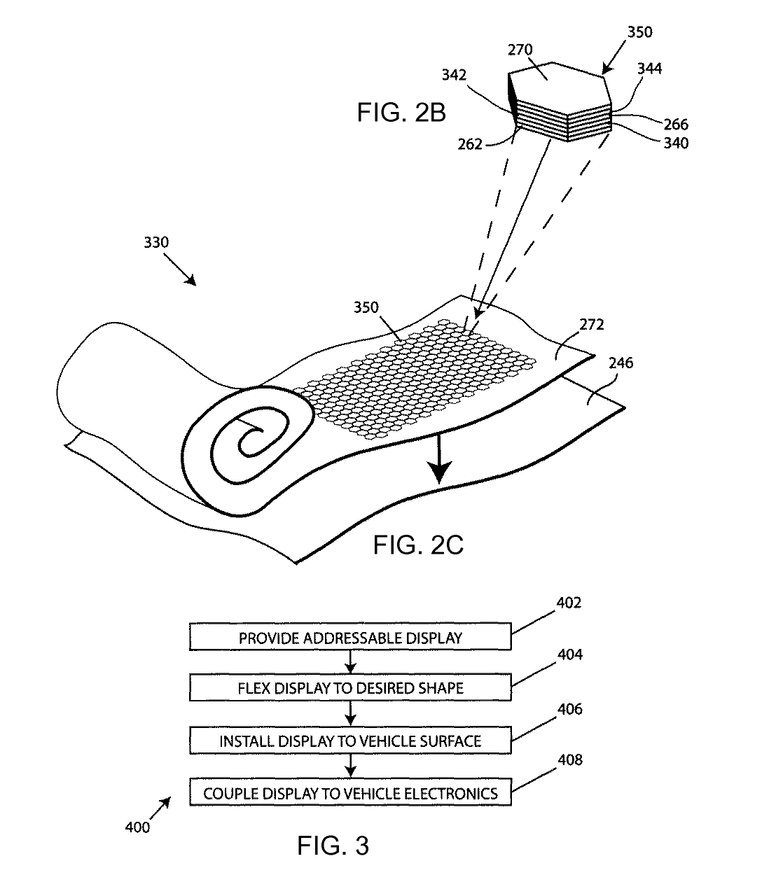

In one exemplary embodiment, the display panel 202 may comprise a Sphere Supported Thin Film Electroluminescent (SSTFEL) device 300 as shown in FIG. 2A and described in U.S. Patent Application Publication No. 2007/0069642 entitled “Sphere Supported Thin Film Phosphor EL Devices”, which is hereby incorporated by reference in its entirety herein. The SSTFEL device 300 may comprise: a flexible, electrically insulated substrate 272 having opposed surfaces 306; 308; an array of generally spherical dielectric particles 304 embedded in the flexible, electrically insulated substrate 272 with each of the spherical dielectric particles 304 having a first portion protruding through one of the opposed surfaces 306 and a second portion protruding through the other of said opposed surfaces 308; an electroluminescent phosphor layer 266 deposited on the first portion of each spherical dielectric particles 304; a continuous electrically conductive, substantially transparent electrode layer 270 located on the top surfaces of the electroluminescent phosphor layer 266 and areas of the flexible electrically insulating substrate 272 located between the top surfaces of the electroluminescent phosphor layer 266; and a continuous electrically conductive electrode layer 262 coated on the second portion of the spherical dielectric particles 304 and areas of the flexible, electrically insulated substrate 272 located between the second portions of the spherical dielectric particles 304, means 316 for applying a voltage between the continuous electrically conductive, substantially transparent electrode layer 270 and the continuous electrically conductive electrode layer 262. The SSTFEL device may be flexed to conform to a surface 246 of a vehicle and attached directly thereto by various means. This arrangement may be encapsulated in a flexible cover (not shown).

In an exemplary embodiment, the SSTFEL device 300 may comprise a phosphor layer 266 deposited onto the top surface of BaTiO₃ spheres 304. A thin SrTi0₃ layer (not shown) may be deposited onto the phosphor layer 266 for effective charge injection into the phosphor layer 266. The BaTiO₃ spheres 304 may be embedded within the polymer layer 272 with the top and bottom areas of the BaTiO₃ spheres 304 exposed. The top area of the BaTiO₃ spheres 304 and the surrounding polymer 272 may be coated with a transparent electrically conducting electrode 270, such as ITO; the bottom area of the BaTiO₃ spheres 304 and surrounding polymer 272 may be coated with another electrically conducting electrode 262, which may be opaque. Any EL phosphor material may be used including, but not limited to, metal oxide or sulfide based EL materials. For example, the sulfide phosphor may be any one of ZnS:Mn or BaAI₂S₄ Eu, or BaAl₄S₇:Eu. The oxide phosphors may preferably be any one of Zn2_{S}SiO_{0.5}Ge_{0.5}O₄:Mn, Zn₂SiO₄:Mn, or Ga₂O₃:Eu and CaAl₂O₄:Eu.

In another embodiment, the display panel may comprise a nixel-based device 330 as shown in FIGS. 2B-C and disclosed in U.S. patent application Ser. No. 11/526,661 entitled “EL Apparatus and Display Incorporating Same,” which is also incorporated by reference herein in its entirety. A nixel 350 is an individually sized and shaped EL apparatus that may be used to form an EL display. Nixels 350 may be manufactured independently and combined with other nixels 350 to form a pixel, a subpixel or a plurality of pixels or subpixels for a display. Nixels can be formed in a variety of shapes and sizes to suit a variety of display applications. As shown in FIG. 3B, a nixel of an exemplary embodiment of the present invention may include a ceramic substrate 340, a first charge injection layer 342 on an upper surface of the ceramic substrate 340, a phosphor layer 266 on top of the first charge injection layer 342, a second charge injection layer 344 on top of the phosphor layer 266, an upper electrode 270 on the upper surface of the second charge injection layer 344 and a lower electrode 262 on the lower surface of the ceramic substrate 340.

As shown in FIG. 2C a plurality of nixels 350 can be attached to a flexible substrate 272 by various means such as by a conductive adhesive and the nixels electrically coupled to provide row and column electrodes and form a flexible EL display. The nixel-based device 330 may then be attached to a vehicle surface 246 so that it conforms to the non-planar surface.

In another embodiment, the display panel may be in the form of a flexible EL display as disclosed in U.S. patent application Ser. No. 11/535,377 entitled “Electroluminescent Display Apparatus and Methods,” which is also incorporated by reference in its entirety herein.

FIG. 3 shows an exemplary method 400 of incorporating the display panel into the vehicle. At block 402 a display panel 202 is provided. At block 404 the display panel 202 is manipulated to a desired shape for installation on a surface of a vehicle. For example, the display panel 202 may be flexed to conform directly to an interior surface of the vehicle, and at least a portion of the interior surface may be non-planar. Alternatively, the display panel 202 may be manufactured to the desired shape. The flexibility and thinness of the display panel allows it to assume any shape or size. This allows for installation on a variety of different surfaces, and removes the need for large base panels and generally planar surfaces in the vehicle. At block 406 the display panel 202 is installed on the interior surface of the vehicle. For example, the display panel 202 may be installed on an interior surface that is forward facing, rearward facing, upward facing, side facing, upward facing, or downward facing or a combination thereof using various means such as using fasteners, adhesives, mounting brackets, etc. At block 408 the display panel may be coupled to display module of the vehicle as discussed in more detail below.

In a certain embodiment, the display unit comprises a plurality of display panels which are installed throughout the interior of the vehicle to provide a view simulating image. The view simulating image may comprise, with respect to the vehicle, at least one of a external forward facing view, an external rear facing view, one or more external side facing views, an external upward facing view, an external downward facing view, and combinations thereof. In a particular embodiment, the display panels may be used to cover substantially all of the entire interior of the vehicle, so that virtually every edge and surface of the interior of the vehicle is covered. This allows the vehicle operator to lose virtually all reference points of the interior of the vehicle. As a result, the vehicle operator becomes immersed in the view simulating image. In a certain embodiment, the plurality of display panels may be adapted to provide a substantially panoramic view of areas surrounding the vehicle. In such embodiments, the detection device and display module would be adapted to receive the requisite physical signals and generate the necessary data and control signals to generate such expansive and even substantially panoramic view simulating images.

The display unit may further comprise a drive unit to supply the appropriate voltages so that the flexible addressable display panel generates light in a desired color and pattern. The drive unit may include a processor and drive circuitry coupled to the row and column electrodes of the flexible addressable display panel. The drive unit may be adapted to control the light emitted from the display pixels by supplying drive signals to the flexible addressable display panel to increase or decrease the voltage at a pixel to turn the pixel on or off and manage the emission of light from the pixels to generate desired images on the display panel.

### II. Display Module

The vehicle display system may also include a display module that is coupled to the display unit and to the detection device. In a particular embodiment, the display module is adapted to receive data signals from the detection device and generate control signals in response to the data signals. The display unit may then receive at least some of the control signals and generate a view simulating image in response to the at least some of the control signals. The display module may be hardware, software, and/or firmware. In an exemplary embodiment, the display module comprises a processor coupled to a memory.

The processor may be adapted to receive the data signals from the detection device and generate the corresponding control signals. The memory may store the necessary programs to operate the processor. As discussed in more detail below, a variety of operational modes may be stored in the memory. These operational modes may be retrieved and used by the processor to govern the characteristics of the control signals generated in response to the data signals. The memory may comprise read only memory (ROM), random access memory (RAM), or some other type memory as the design requires.

The display module may be adapted to run under a variety of operational modes. These various operational modes may be stored in the memory. The selection of the operational mode may change at least one characteristic of the control signals generated in response to the data signals. The operational modes may be selected by a vehicle operator, or may be selected automatically based upon predetermined criteria such as the occurrence of a predetermined type of data signal from the detection device.

In one embodiment, the operational mode is selected by a vehicle operator through at least one user input device coupled to the display module. The user input device may be a switch, mouse, scroll wheel, keypad, voice activation system, or any other input device known in the art. In a preferred embodiment, the user input device is a touch screen mounted over the display panel. The user input device may be adapted to receive input from the user and generate selection signals in response to the input from the user. The display module may be adapted to receive the selection signals from the user input device and select an operational mode in response to the user input. For example, if the user flips a switch to night mode, then the switch may send a night mode selection signal to the display module. In response to receiving the selection signal, the display module would select a night operational mode. This selection may change a characteristic of the control signals generated in response to the data signals. For example, the selection of the night operational mode may change the characteristics of the control signals so that the spectral range and/or the intensity range of the light represented in the view simulating image is increased.

In another embodiment, the display module is adapted to automatically select an operational mode in response to receiving a predetermined type of data signal from the detection device. For example, if the data signals from a visible light detection device indicate that the amount of light has fallen below a predetermined threshold, the display module may select a night operational mode. The selection of the night operational mode may then change the characteristics of the control signals so that the spectral range and/or the intensity range of the light represented in the view simulating image is increased.

The display module may be adapted for communication with a user input device adapted for communication with a user input device that is adapted to receive location specific input from a vehicle operator. In a preferred embodiment, the input device is a mouse or a touch screen. The user input device may receive the location specific input from the user and generate location specific selection signals in response to the input, the display module may receive the location specific selection signals from the input device and generate location specific secondary control signals, and the display unit may receive the location specific secondary control signals from the display module and generate a location specific secondary image in response to the control signals. For example, the vehicle user may observe a potential target on the view simulating image. The vehicle user may then touch the touch screen mounted over the display panel, and the touch screen may then generate a location specific selection signal. In response to receiving the selection signal from the touch screen, the display module may then create a location specific secondary control signal, and in response to receiving the secondary control, the display unit may then generate a location specific secondary image, such as a target or crosshair, on a specific location of the view simulating image. The specific location may be the location indicated by the user on the touch screen, and the display module may continue to generate location specific secondary control signals so that the location of the secondary image tracks the movement of the target. In a particular embodiment, the secondary image may appear to be semitransparent. For example, the secondary image may appear to be a highlight that covers the target and allows the target to be visible from underneath the highlight.

In a particular embodiment, the location specific secondary image is an image of a gauge. The gauge may be a speedometer, tachometer, headlight indicator, oil pressure gauge, fuel gauge, temperature gauge, voltmeter, turn signal indicator, cruise control indicator, fuel economy indicator, navigation indicator, or any other gauge known in the art. The display module may generate the location specific secondary control signal so that the location of the gauge appears in a location indicated by the user input device. In one embodiment, the user may indicate the location for the gauge using an input device such as a touch screen mounted over the display panel. In another embodiment, the location for the gauge is indicated with an input device such as a line of vision sensing device worn on the head of the vehicle operator. The line of vision sensing device may generate a location specific selection signal to indicate the panel location in which the operator is focusing their vision, and the image of the gauge may then be located in an area of the display panel that is easily observed by the operator.

In another embodiment, the display module is adapted to automatically generate secondary control signals in response to a predetermined type of data signal from the detection device. The display unit may then receive the secondary control signals and generate a secondary image in response to the secondary control signals. The secondary image may comprise a message or a signal. For example, if the data signals from a sound detection device indicate that the level of an aircraft sound has risen above a predetermined threshold, the display module may generate a secondary control signal. In response to the secondary control signal, the display unit may generate a secondary image comprising an “incoming aircraft” message on the display panel.

The display module also may be adapted to generate a location specific secondary control signal in response to a predetermined type of data signal. The display unit may then receive the location specific secondary control signal and generate a location specific secondary image in response to the secondary control signal. For example, if the data signals from an electromagnetic signal detection device indicate that an object is broadcasting a location indicating electromagnetic signal, the display module may generate a location specific control signal. In response to the location specific control signal, the display unit may generate a location specific secondary image comprising a highlight or target on the display panel. The secondary image may appear on the display panel in the area of the view simulating image indicated by the location indicating electromagnetic signal. In a particular embodiment, the secondary image may appear to be semitransparent. For example, the secondary image may appear to be a highlight that covers the location and allows the location to be visible from underneath the highlight.

### III. Detection Device

The vehicle display system may also include a detection device that is adapted for communication with the display module. In a particular embodiment, the detection device is adapted to receive physical signals from outside the vehicle and generate control signals in response to the data signals. The display unit may then receive at least some of the data signals and generate control signals in response to the at least some of the control signals.

The physical signals may be at least one of light, sound, heat, electromagnetic signals, electric fields, and magnetic fields. The detection device may be a video camera, infrared camera, rangefinder, night vision camera, ultraviolet camera, microphone, radar device, compass, or any other detection device known in the art. Preferably, the detection device is a video camera, and the physical signals are visible light.

### IV. Vehicle

In another embodiment, a vehicle is provided that comprises a carrier and a vehicle display system for displaying a view simulating image. The carrier may be any vehicle known in the art, non-limiting examples of which include automobiles, tanks, watercraft such as boats and submarines, and aircraft such as planes, blimps, and helicopters. The carrier preferably comprises a vehicle in which window size is limited by the need for structural strength or protection, such as a tank or an aircraft. The vehicle display system of the vehicle may comprise any of the vehicle display systems that are described above.

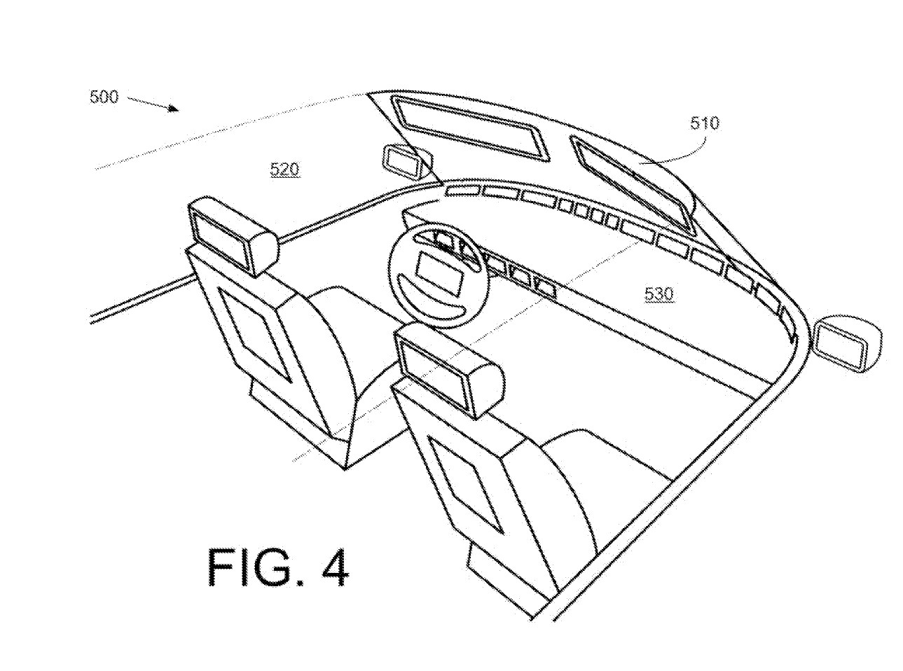

The vehicle may comprise an automobile 500 as shown in FIG. 4. The vehicle may comprise a vehicle display system which may comprise at least one display panel mounted inside the vehicle on interior surfaces 510, 520, and 530. The display panels on at least one of interior surfaces 510, 520, and 530 may provide the vehicle operator with a view simulating image that comprises a forward facing view, side facing view, and downward facing view, respectively. In a certain embodiment, such an image may be substantially panoramic.

### V. Method of Navigation

In another embodiment, a method of navigating a vehicle is provided that comprises receiving physical signals from outside the vehicle with a detection device; generating data signals with the detection device in response to the physical signals; receiving the data signals with a display module; generating control signals with the display module in response to the data signals; receiving at least a portion of the control signals with a display unit comprising at least a first flexible addressable display panel mounted inside the vehicle; generating at least a portion of a view simulating image with the flexible display panel in response to the control signals; and navigating the vehicle in response to the view simulating image.

The step of navigating the vehicle may comprise any method of using the vehicle, non-limiting examples of which include steering, accelerating, braking, targeting, shooting, or bombing.

The vehicle may be any vehicle known in the art, non-limiting examples of which include automobiles, tanks, watercraft such as boats and submarines, and aircraft such as planes, blimps, and helicopters. The vehicle preferably comprises a vehicle in which window size is limited by the need for structural strength or protection, such as a tank or an aircraft. The display unit, display module, and detection device may comprise, respectively, any of the display units, display modules, and detection devices that are described above.

It should be apparent that the foregoing relates only to the preferred embodiments of the present application, and that numerous modifications and changes may be made herein by one of ordinary skill in the art without departing from the general spirit and scope of the invention as defined by the following claims and the equivalents thereof.

What is claimed is:

1. A vehicle display system for displaying a view simulating image inside a vehicle based on physical signals from outside the vehicle, comprising:
a detection device adapted to receive physical signals from outside the vehicle and generate data signals in response to the physical signals;
a display module adapted for communication with the detection device, wherein the display module is adapted to receive the data signals from the detection device and to generate control signals in response to the data signals; and
a display unit comprising at least a first flexible addressable display panel adapted for communication with the display module, wherein the first flexible display panel is adapted for mounting inside the vehicle and to receive at least some of the control signals from the display module and to generate at least a portion of the view simulating image in response to the at least some of the control signals.

2. The vehicle display system of claim 1, wherein the first flexible addressable display panel is mounted directly on an interior surface of the vehicle.

3. The vehicle display system of claim 2, wherein at least a portion of the interior surface of the vehicle is non-planar.

4. The vehicle display system of claim 1, wherein the physical signals are at least one of light, sound, heat, electromagnetic signals, electric fields, and magnetic fields.

5. The vehicle display system of claim 1, wherein the display unit comprises a plurality of flexible addressable display panels including the first flexible display panel, the plurality of flexible addressable display panels being adapted for communication with the display module and adapted for mounting inside the vehicle and to receive the control signals from the display module and to generate the view simulating image in response to the control signals.

6. The vehicle display system of claim 1, wherein:
the display module is further adapted to generate secondary control signals in response to receiving a predetermined type of data signal from the detection device; and
the flexible addressable display panel is adapted to receive the secondary control signals from the display module and to generate a secondary image in response to the secondary control signals.

7. The vehicle display system of claim 6, wherein the secondary image comprises at least one of a message and a signal.

8. The vehicle display system of claim 1, wherein:
the display module is further adapted to generate location specific secondary control signals in response to receiving predetermined types of data signals from the detection device; and
the flexible addressable display panel is further adapted to receive the location specific secondary control signals from the display module and generate a location specific secondary image in response to the location specific secondary control signals, wherein the location specific secondary image is generated on a specific location of the view simulating image.

9. The vehicle display system of claim 1, further comprising:
a user input device adapted for communication with the display module, wherein the user input device is adapted to receive input from a user and generate selection signals in response to the input from the user; and
wherein the display module is adapted to receive the selection signals from the user input device and to select an operational mode in response to the user input.

10. The vehicle display system of claim 9, wherein the operational mode changes at least one characteristic of the control signals generated in response to the data signals.

11. The vehicle display system of claim 9, wherein the user input device comprises a touch screen mounted over the flexible addressable display panel.

12. The vehicle display system of claim 1, further comprising:
a user input device adapted for communication with the display module, wherein the user input device is adapted to receive location specific input from the user and generate location specific selection signals in response to the input from the user; and
wherein the display module is further adapted to receive the location specific selection signals from the user input device and generate location specific secondary control signals in response to the location specific selection signals; and
the flexible addressable display panel is further adapted to receive the location specific secondary control signals from the display module and generate a location specific secondary image in response to the location specific secondary control signals, wherein the location specific secondary image is generated on a specific location of the view simulating image.

13. The vehicle display system of claim 1, wherein the display module is adapted to select an operational mode in response to receiving a predetermined type of data signal from the detection device.

14. The vehicle display system of claim 1, wherein the view simulating image comprises, with respect to the vehicle, an external forward facing view, an external rearward facing view, and one or more external side facing views.

15. The vehicle display system of claim 14, wherein the view simulating image further comprises, with respect to the vehicle, an external upward facing view.

16. The vehicle display system of claim 14, wherein the view simulating image further comprises, with respect to the vehicle, an external downward facing view.

17. The vehicle display system of claim 1, wherein the view simulating image comprises an external substantially panoramic view of area surrounding the vehicle.

18. A vehicle comprising a carrier and a vehicle display system for displaying a view simulating image inside a vehicle based on physical signals from outside the vehicle, the vehicle display system comprising:
a detection device adapted to receive physical signals from outside the vehicle and generate data signals in response to the physical signals;
a display module adapted for communication with the detection device, wherein the display module is adapted to receive the data signals from the detection device and generate control signals in response to the data signals; and
a display unit comprising at least a first flexible addressable display panel adapted for communication with the display module, wherein the first flexible display panel is mounted inside the vehicle and is adapted to receive at least some of the control signals from the display module and generate at least a portion of the view simulating image in response to the at least some of the control signals.

19. The vehicle of claim 18, wherein the first flexible addressable display panel is mounted directly on an interior surface of the vehicle.

20. The vehicle of claim 19, wherein at least a portion of the interior surface of the vehicle is non-planar.

21. The vehicle display system of claim 18, wherein the physical signals are at least one of light, sound, heat, electromagnetic signals, electric fields, and magnetic fields.

22. The vehicle display system of claim 18, wherein the display unit comprises a plurality of flexible addressable display panels including the first flexible display panel, the plurality of flexible addressable display panels being adapted for communication with the display module and adapted for mounting inside the vehicle and to receive the control signals from the display module and to generate the view simulating image in response to the control signals.

23. The vehicle display system of claim 18, wherein:
the display module is further adapted to generate secondary control signals in response to receiving a predetermined type of data signal from the detection device; and
the flexible addressable display panel is adapted to receive the secondary control signals from the display module and to generate a secondary image in response to the secondary control signals.

24. The vehicle display system of claim 23, wherein the secondary image comprises at least one of a message and a signal.

25. The vehicle display system of claim 18, wherein:
the display module is further adapted to generate location specific secondary control signals in response to receiving predetermined types of data signals from the detection device; and
the flexible addressable display panel is further adapted to receive the location specific secondary control signals from the display module and generate a location specific secondary image in response to the location specific secondary control signals, wherein the location specific secondary image is generated on a specific location of the view simulating image.

26. The vehicle display system of claim 18, further comprising:
a user input device adapted for communication with the display module, wherein the user input device is adapted to receive input from a user and generate selection signals in response to the input from the user; and
wherein the display module is adapted to receive the selection signals from the user input device and to select an operational mode in response to the user input.

27. The vehicle display system of claim 26, wherein the operational mode changes at least one characteristic of the control signals generated in response to the data signals

28. The vehicle display system of claim 26, wherein the user input device comprises a touch screen mounted over the flexible addressable display panel.

29. The vehicle display system of claim 26, further comprising:
a user input device adapted for communication with the display module, wherein the user input device is adapted to receive location specific input from the user and generate location specific selection signals in response to the input from the user; and
wherein the display module is further adapted to receive the location specific selection signals from the user input device and generate location specific secondary control signals in response to the location specific selection signals; and
the flexible addressable display panel is further adapted to receive the location specific secondary control signals from the display module and generate a location specific secondary image in response to the location specific secondary control signals, wherein the location specific secondary image is generated on a specific location of the view simulating image.

30. The vehicle display system of claim 18, wherein the display module is adapted to select an operational mode in response to receiving a predetermined type of data signal from the detection device.

31. The vehicle display system of claim 18, wherein the view simulating image comprises, with respect to the vehicle, an external forward facing view, an external rearward facing view, and one or more external side facing views.

32. The vehicle display system of claim 31, wherein the view simulating image further comprises, with respect to the vehicle, an external upward facing view.

33. The vehicle display system of claim 31, wherein the view simulating image further comprises, with respect to the vehicle, an external downward facing view.

34. The vehicle display system of claim 18, wherein the view simulating image comprises an external substantially panoramic view of area surrounding the vehicle.

35. A method for navigating a vehicle, comprising:
receiving physical signals from outside the vehicle with a detection device;
generating data signals with the detection device in response to the physical signals;
receiving the data signals with a display module;
generating control signals with the display module in response to the data signals;
receiving at least a portion of the control signals with a display unit comprising at least a first flexible addressable display panel mounted inside the vehicle;
generating at least a portion of a view simulating image with the flexible display panel in response to the control signals; and
navigating the vehicle in response to the view simulating image.

36. The method of claim 35, wherein the first flexible addressable display panel is mounted directly on an interior surface of the vehicle.

37. The method of claim 36, wherein at least a portion of the interior surface of the vehicle is non-planar.

38. The method of claim 35, wherein the step of receiving physical signals comprises receiving at least one of light, sound, heat, electromagnetic signals, electric fields, and magnetic fields.

39. The method of claim 35, wherein the display unit comprises a plurality of flexible addressable display panels including the first flexible display panel, the plurality of flexible addressable display panels being adapted for communication with the display module and adapted for mounting inside the vehicle and to receive the control signals from the display module and to generate the view simulating image in response to the control signals.

40. The method of claim 35, wherein:
the display module is further adapted to generate secondary control signals in response to receiving a predetermined type of data signal from the detection device; and
the flexible addressable display panel is adapted to receive the secondary control signals from the display module and to generate a secondary image in response to the secondary control signals.

41. The method of claim 40, wherein the secondary image comprises at least one of a message and a signal.

42. The method of claim 35, wherein:
the display module is further adapted to generate location specific secondary control signals in response to receiving predetermined types of data signals from the detection device; and
the flexible addressable display panel is further adapted to receive the location specific secondary control signals from the display module and generate a location specific secondary image in response to the location specific secondary control signals, wherein the location specific secondary image is generated on a specific location of the view simulating image.

43. The method of claim 35, further comprising:
a user input device adapted for communication with the display module, wherein the user input device is adapted to receive input from a user and generate selection signals in response to the input from the user; and
wherein the display module is adapted to receive the selection signals from the user input device and to select an operational mode in response to the user input.

44. The method of claim 43, wherein the operational mode changes at least one characteristic of the control signals generated in response to the data signals

45. The method of claim 43, wherein the user input device comprises a touch screen mounted over the flexible addressable display panel.

46. The method of claim 35, further comprising:
a the user input device adapted for communication with the display module, wherein the user input device is adapted to receive location specific input from the user and generate location specific selection signals in response to the input from the user; and
wherein the display module is further adapted to receive the location specific selection signals from the user input device and generate location specific secondary control signals in response to the location specific selection signals; and
the flexible addressable display panel is further adapted to receive the location specific secondary control signals from the display module and generate a location specific secondary image in response to the location specific secondary control signals, wherein the location specific secondary image is generated on a specific location of the view simulating image.

47. The method of claim 35, wherein the display module is adapted to select an operational mode in response to receiving a predetermined type of data signal from the detection device.

48. The method of claim 35, wherein the view simulating image comprises, with respect to the vehicle, an external forward facing view, an external rearward facing view, and one or more external side facing views.

49. The method of claim 48, wherein the view simulating image further comprises, with respect to the vehicle, an external upward facing view.

50. The method of claim 48, wherein the view simulating image further comprises, with respect to the vehicle, an external downward facing view.

51. The method of claim 35, wherein the view simulating image comprises an external substantially panoramic view of area surrounding the vehicle.
